(19) United States
(12) Patent Application Publication
(10) Pub. No.: US 2009/0279080 A1
(43) Pub. Date: Nov. 12, 2009

(54) DEVICE AND METHOD FOR THE INSPECTION OF DEFECTS ON THE EDGE REGION OF A WAFER

(75) Inventors: Lambert Danner, Wetzlar (DE); Michael Heiden, Wolfersheim (DE); Wolfgang Vollrath, Burbach (DE); Alexander Buttner, Weilburg (DE); Christof Krampe-Zadler, Castrop-Rauxel (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Weilburg (DE)

(21) Appl. No.: 12/494,858

(22) Filed: Jun. 30, 2009

Related U.S. Application Data
(63) Continuation of application No. PCT/EP2008/051339, filed on Feb. 4, 2008.
(60) Provisional application No. 60/895,700, filed on Mar. 19, 2007.

(30) Foreign Application Priority Data
Mar. 19, 2007 (DE) 10 2007 013 655.4
Dec. 21, 2007 (DE) 10 2007 047 935.4

(51) Int. Cl. G01N 21/88

(52) U.S. Cl. 356/237.3

(57) ABSTRACT

A method, a device and the application for the inspection of defects on the edge region of a wafer (6) is disclosed. At least one illumination device (41) illuminates the edge region (6a) of the wafer (6). At least one optical unit (40) is provided, said optical unit (40) being positionable subject to the position of the defect (88) relative to a top surface (30) of the edge of the wafer (6a) or a bottom surface (31) of the edge of the wafer (6a) or a face (32) of the edge of the wafer (6a) for capturing an image of said defect.

### RELATED APPLICATIONS

This application is a Continuation of International Application No. PCT/EP2008/015339, filed on Feb. 4, 2008, which claims priority to German Patent Application Nos. DE 10 2007 013 655.4, filed on Mar. 19, 2007, and DE 10 2007 047 935.4, filed on Dec. 21, 2007, and claims the benefit under 35 USC 119(e) of U.S. Provisional Application No. 60/895,700, filed on Mar. 19, 2007, all of which are incorporated herein by reference in their entirety.

### FIELD OF THE INVENTION

The present invention relates to a device for the inspection of defects on the edge region of a wafer.

In addition, the invention relates to a method for the inspection of defects on the edge region of a wafer.

### BACKGROUND OF THE INVENTION

Japanese patent application JP 2006/294969 A discloses an inspection equipment for wafers which captures images of the circumferential edge of the wafer. Preferably the edge region of the wafer is being inspected to that effect whether any abnormality exists or not. The inspection equipment for the wafer comprises a supporter for supporting the wafer in a horizontal plane. Furthermore, one camera is provided, which captures a circumferential edge of the wafer. Thereby, the camera can be moved on an arcuately shaped channel about the angle of the wafer. During the movement of the camera, images of the circumferential angle of the wafer are captured.

Korean patent application KR 102004094967 A discloses an apparatus for inspecting the angle of the wafer which is additionally suitable for reducing a time for the inspection process. A plurality of optical sensors is arranged nearly to an edge part of the wafer. Each optical sensor comprises a light emitting unit for illuminating the angle of the wafer. Furthermore, each sensor comprises a receiving part for receiving the light reflected from the angle of the wafer. The apparatus suggested in this Korean patent application, however, is not suitable for capturing single images of selected defects. The apparatus serves merely for finding defects on the edge of the wafer.

U.S. Pat. No. 7,161,669 comprises a first drive equipment and a second drive equipment which are moving a recording head horizontally above the surface of a wafer. With it, data regarding various characteristic elements are provided on the surface of the wafer. The second drive equipment comprises a motor, which moves the drive equipment about the edge of the wafer so that the bottom surface of the wafer can be recorded. Likewise, this device also cannot approach single positions of defects on the edge of the wafer and cannot capture images of these defects.

US-Patent 2005/0060104 comprises an apparatus for the inspection of the angle of a wafer including a review tool which captures images of the semiconductor wafer. Thereby, points of interest proximate to the angle of the wafer are being approached and images captured there automatically. The captured images are stored in a database and are computer-searchable for detailed defect analysis. The document discloses not, however, if the camera is arranged in a flexible way in order to capture images according to ones desires and needs from the top surface of the edge of the wafer, from the edge of the wafer itself and/or from the bottom surface of the edge of the wafer.

### SUMMARY OF THE INVENTION

The object of the present invention is to create a device with which a reliable inspection of defects on the edge of the wafer is possible. Thereby, the device should have the ability to examine the defects on the top surface of the edge of the wafer, on the angle of the wafer and on the bottom surface of the edge of the wafer.

The object of the invention is achieved by a device for the inspection of defects on an edge region of a wafer comprising:
at least one illumination device, which illuminates the edge region of the wafer;
a detector, which captures an image of the edge region of the wafer with a defined image field size; and
at least an optical unit, wherein said optical unit being positionable subject to the position of the defect relative to a top surface of the edge of the wafer or a bottom surface of the edge of the wafer or a face of the edge of the wafer for capturing an image of said defect.

Furthermore, the object of the present invention is to create a method for the reliable inspection of defects on the edge region of a wafer, with which both the defects on the top surface of the edge of the wafer and on the angle of the edge of the wafer and on the bottom surface of the edge of the wafer can be examined.

The object is achieved by a method for the inspection of defects on the edge region of a wafer, comprising the following steps:
positioning the wafer on the basis of stored positioning data in such a way that the defects for inspection are located in the image area of at least one optical unit;
positioning the at least one optical unit for image acquisition with a detector subject to the position of the defect relative to the top surface of the edge of the wafer or to the bottom surface of the edge of the wafer or to the face of the edge of the wafer; and
displaying the captured images for the user on a display or storing said captured images for later processing.

It is advantageous that the device for the inspection of defects is applicable on the edge region of a wafer. At least one illumination device is provided which illuminates the edge region of the wafer. A detector captures an image of the edge region of the wafer with a defined image field size. At least one optical unit is provided wherein said optical unit being positionable subject to the position of the defect relative to a top surface of the edge of the wafer or a bottom surface of the wafer edge or a face of the wafer edge for capturing an image of said defect.

With the at least one illumination device a plurality of illuminating techniques and/or contrast methods is realizable. The illuminating techniques and/or contrast methods are the bright field illumination, the dark field illumination, the interference contrast and the differential interference contrast.

Each of the optical units is designed as a module being arranged pivotable about an axis having at least one objective for illumination and image acquisition of the defect, the at least one illumination device and the detector and a focusing device.

The at least one optical unit having a first pivotable module having at least an objective and a mirror arrangement. The first pivotable module is connected via a joint with a stationary second module having at least one optic for illumination and image acquisition of the defect, the illumination device, the detector and a focusing device.

The optical unit having a first pivotable module comprising a mirror arrangement wherein said mirror arrangement is connected via a joint with a stationary second module comprising the illumination device, the detector and a focusing device.

A magnification changer is provided in front of the detector in the detection beam path of the optical unit. Likewise, a pupil is arranged past the magnification changer and in front of the detector in the detection beam path.

In the stationary second module a variable aperture diaphragm is positioned past the joint.

Furthermore, at least one lense in addition to the objective is provided in the pivotable second module.

The optical unit can also comprise at least two objectives and a mirror arrangement, wherein the objectives and the mirror arrangement are positioned in a first pivotable module. As already mentioned above, the first pivotable module is connected via a joint with a stationary second module. The second stationary module comprises at least the illumination device, the detector and a focusing device.

Thereby, the at least two objectives can be positioned on a rotatable turret. Likewise, it is possible that the at least two objectives are positioned on a slider.

The detector is an image acquisition detector such as a CCD-chip or a CMOS for example.

As for the method for the inspection of defects on the edge region, the wafer is positioned on the basis of stored positioning data in such a way that the defects for the inspection are located in the image area of at least one optical unit. The at least one optical unit is positionable for image acquisition with a detector subject to the position of the defect relative to the top surface of the edge region of the wafer or to the bottom surface of the edge region of the wafer or to the face of the edge region of the wafer. The captured images can be displayed on a display to the user. Likewise, it is possible to store said captured images for later processing.

Furthermore, the device according to the invention is used during the inspection of defects on the edge region of a wafer in an inspection device for wafers. The inspection device comprises a plurality of units for the inspection of a wafer. Likewise, at least one display is provided onto which the captured images of the defects are displayed to a user. At least one unit for the inspection of defects on the edge region of the wafer is provided which is designed in such a way that the unit comprises at least one optical unit which is positionable subject to the position of the defect relative to the top surface of the edge of the wafer or to the bottom surface of the edge of the wafer or to the face of the edge of the wafer for capturing an image of the defect.

The inspection device consists of a plurality of working stations and at least one substrate feeding module. The plurality of working stations are constructed in such a way that in each case different inspections are to be carried out on the wafer and said working stations are arranged about a central unit, wherein said modules are designed in such a way that they are optionally interchangeable against each other.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a perspective view of a working station for the inspection of the surface of wafers.

FIG. 2 shows a schematic view of an embodiment of an inspection device for wafers consisting of one substrate feeding module and at least three working stations.

FIG. 3 shows a simplified schematic view of the device according to the invention, wherein an objective and an optical unit respectively can be pivoted subject to the position of the defect on the edge of the wafer in such a way that an image of the defect can be captured.

FIG. 4 shows schematically the position of the optical axis of the optical unit related to the edge region of the wafer.

FIG. 5 shows a schematic view of an optical unit for recording an image of a defect on the top surface, the bottom surface or the face of the edge of the wafer.

FIG. 6 shows a schematic view of the optical device for recording an image of a defect on the edge of the wafer, wherein the device is composed of one movable module and one stationary module.

FIG. 7 shows another embodiment of the construction of the optical device, wherein the device is composed of one movable module and one stationary module.

FIG. 8 shows another embodiment of the optical device for recording an image on the edge of the wafer, wherein said optical device is composed of one stationary module and one movable and pivotable module respectively.

FIG. 9 shows another embodiment of the optical device for recording an image of a defect on the edge of the wafer, wherein said optical device consists of a stationary module and of a module being pivotable about a rotary axis.

FIG. 10 shows another embodiment of the optical device for recording an image from the edge of the wafer, wherein the first pivotable module is provided with at least two objectives for image acquisition.

FIG. 11 shows another embodiment of the optical device, wherein two objectives are provided in the first pivotable module of the device for recording an image of defects on the edge of the wafer.

FIG. 12 shows another embodiment of the optical device for recording an image of a defect from the edge of the wafer, wherein an objective with one sole magnification is provided in the first pivotable module and the further magnification possibility is arranged in the stationary second module.

FIG. 13 shows a schematic view of a wafer, wherein a plurality of defects are marked symbolically on the edge of the wafer.

### DETAILED DESCRIPTION OF THE PREFERRED EMBODIMENTS

Same reference numbers refer to same elements throughout the various figures. This should not be regarded as a limitation of the invention.

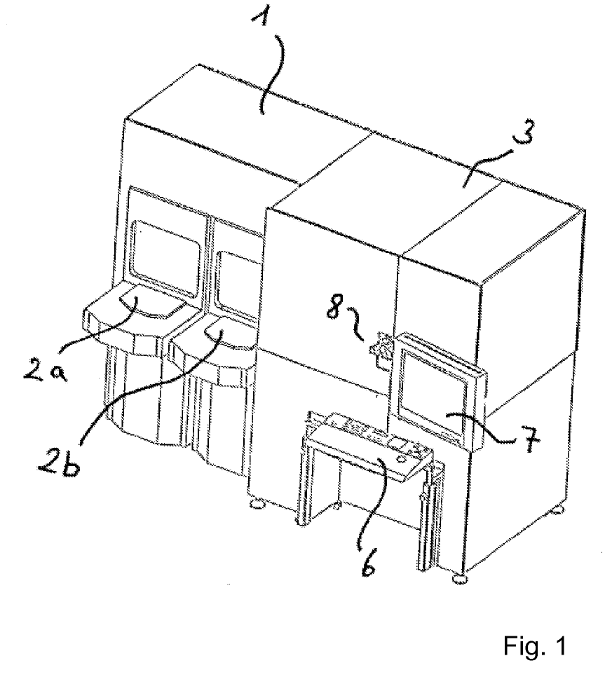

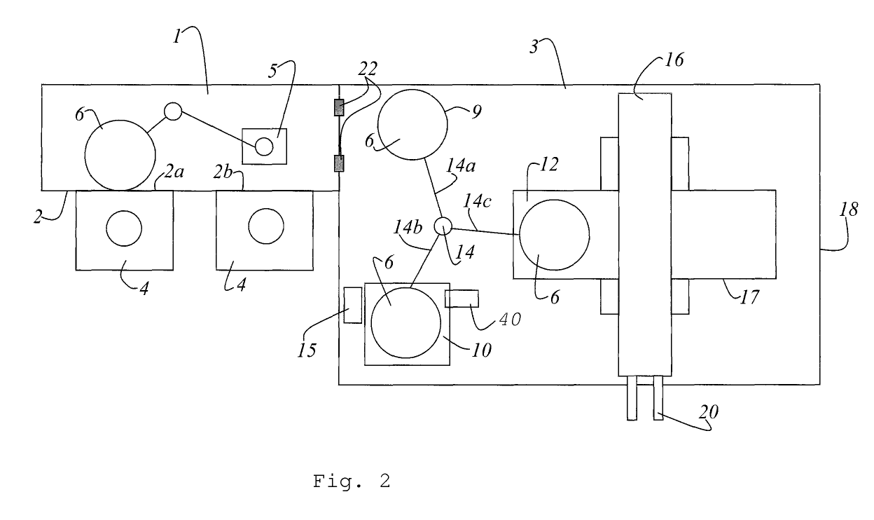

FIG. 1 shows a perspective view of an inspection device 3 for wafers, wherein the device according to the invention is used. The inspection device 3 comprises a substrate feeding module 1 and at least one working station (here not shown; see FIG. 2). Further, the inspection device 3 is provided with a monitor 7, with which the user can control his carried out inputs via the control panel 6. Likewise, the captured images of the defects on the edge of the wafer or on the top surface of the wafer itself captured by the working station or the working stations are visually displayed to the user on the monitor 7. Further, the substrate can be directly observed and examined with a microscope via a microscope ocular 8. The substrate feeding module 1 is provided on the face with a plurality of load ports 2a, 2b, via which the inspection device 3 can be supplied with wafers.

FIG. 2 shows schematically a principle construction of an inspection device 3 having internally a plurality of working stations 9, 10, 12. Special working stations 9, 10, 12 are shown here, it is obvious for a skilled person, however, that any types of working stations can be arranged to an inspection device 3. The substrate feeding module 1 is oriented in this embodiment over the inspection device 3 in such a way that it can be loaded with substrates from its face 2 via one or more load ports 2a, 2b. Normally, two load ports 2a, 2b are provided. Thereby, open or closed cassettes 4 are used which are inserted into the load ports 2a, 2b either manually by the user or by means of automation by a robot (not shown), for example. The cassettes 4 are either filled with wafers 6 or can also be empty depending on the intended working operation. For example, all cassettes 4 can be filled and wafers 6 are being taken firstly from one cassette, then inserted into the inspection device 3 and after inspection and control returned again to the same cassette 4. Inside the substrate feeding module 1, a transport robot 5 is provided which transports the wafers 6 into the inspection device 3. The arrangement of the substrate feeding module 1 in FIG. 2 shows only one of a plurality of embodiments.

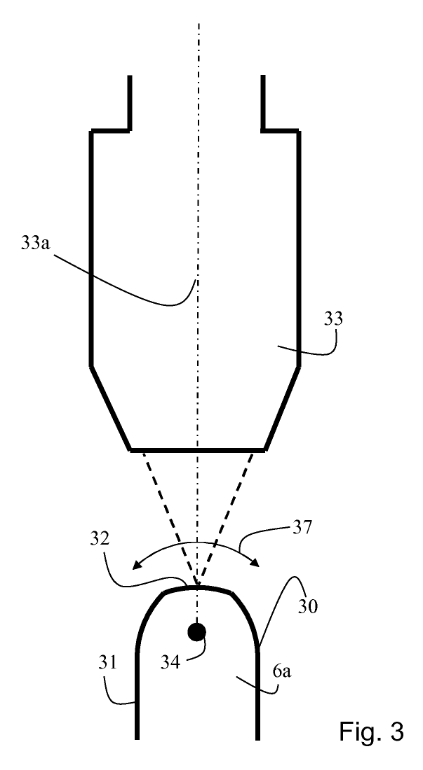

As already mentioned, the inspection device 3 comprises a plurality of working stations 9, 10, 12. At the working stations 9, 10 and 12, appropriate tests, controls and inspections are carried out on the wafer 6. In the present embodiment three working stations are provided in the inspection device, namely a first, a second and a third working station 9, 10, 12. Centrally between the working stations 9, 10 and 12 a changer 14 for the wafer 6 is positioned. The changer 14 has three arms 14a, 14b and 14c, with which the individual working stations 9, 10 and 12 can be simultaneously supplied with wafers 6. The first working station 9 serves for takeover from the substrate feeding module and for handover to the substrate feeding module respectively. The second working station 10 servers for alignment, for determining the positioning and for visual inspection of the wafer 6 respectively. For aligning the wafers 6, a measuring device 15 is provided for the second working station 10, wherein said measuring device 15 detects marks applied on the wafer and defines encodings of the wafer 6. Further, the measuring device 15 determines the deviation of the exactly positioned storage of the wafer 6 in the second working station 10. The data determined in such a way are being forwarded to a central processing unit (not shown). The third working station 12 is constructed for micro-inspection of the wafer 6. The third working station 12 is provided with an X/Y-stage 17, which transports the wafers 6 to a microscope 16 for micro-inspection. The microscope 16 in the embodiment disclosed herein is provided with an ocular 20, wherein said ocular 20 enables an user to carry out a visual micro-inspection of the wafer to be examined. The device 40 for visual inspection of defects on the top surface, the bottom surface and/or the face of the wafer 6 is provided in the second working station 10. Possible embodiments of the device for the inspection of the wafer 6 are described in detail in the following FIGS. 3 to 11. An inspection device 3 can thereby be constructed entirely in a modular way. A central unit could be provided, for example, about all inspection devices and inspection elements respectively are grouped around. In each provided inspection element, another examination can be carried out on the wafer. It is also possible that several examination methods are carried out at one inspection element. Thereby, the individual inspection elements are designed in such a way that they can be exchanged anytime in their position at the central unit. The device and the method for visual assessment of defects on the edge of the wafer can thereby be implemented to one sole element for the inspection of wafers. Likewise, the device and the method can also be implemented additionally in a module to another inspection device. The device 40 for the inspection of defects on the top surface 30, the bottom surface 31 or the face 32 of the edge of the wafer 6a can be provided at the second working station 10. It is obvious for a skilled person that not only one device 40 for the inspection of defects on the top surface 30, the bottom surface 31 or the face 32 of the edge of the wafer 6a can be provided at the second working station 10 but several devices.

FIG. 3 shows a schematic construction of the device for visual assessment of defects on the top surface 30 of the edge of the wafer 6a, on the bottom surface 31 of the edge of the wafer 6a and on the face 32 of the edge of the wafer 6a. As for visual inspection of the defects on the edge of the wafer, at least a microscope-objective 33 must be positioned relative to the edge of the wafer 6a (top surface 30, bottom surface 31 or face 32). The positioning of the microscope-objective 33 is carried out about an axis of rotation 34 arranged perpendicular to the plane of projection.

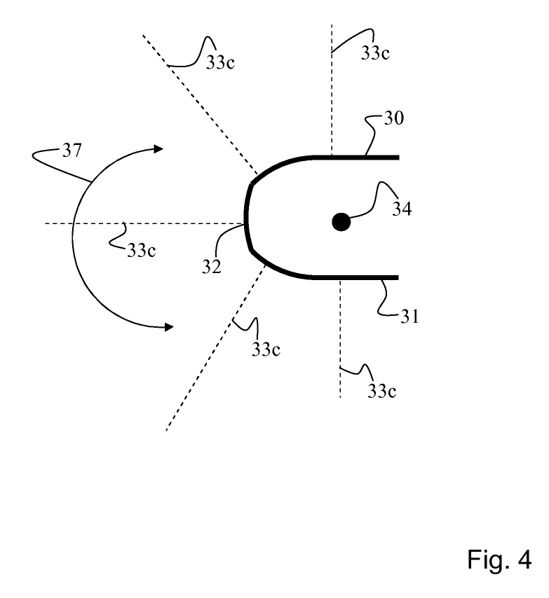

The microscope-objective 33 has an optical axis 33c (see FIG. 3 and FIG. 4) and is to be positioned as for the top surface 30, the bottom surface 31 or the face 32 of the edge of the wafer 6a in such a way that the optical axis 33c of the microscope-objective 33 is perpendicular to the respective measuring position and image acquisition position respectively. As indicated in FIGS. 3 and 4, the measurement objective is being pivoted about the edge of the wafer 6a according to the double arrow 37 and hence brought into the necessary position for the image acquisition.

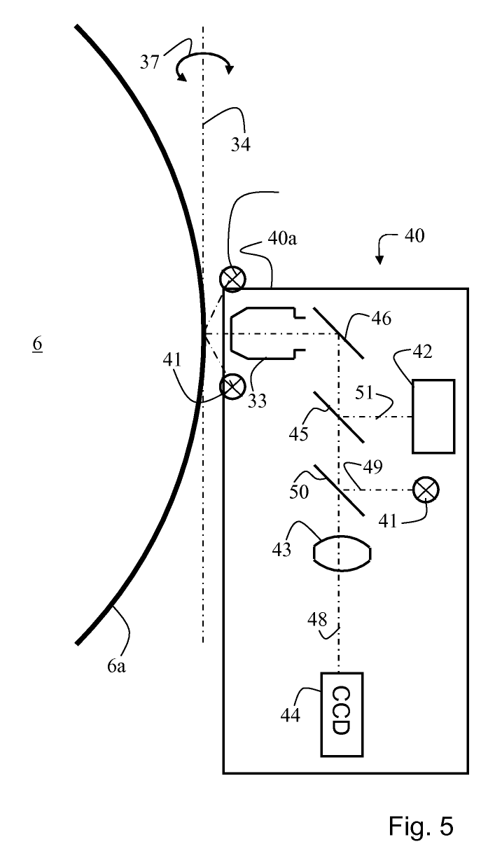

FIG. 5 shows a schematic view of an embodiment of the device for the inspection of defects on the region 6a of a wafer 6. The result of the image acquisition by means of the device serves also for visual assessment of the defects on the edge of the wafer 6a. The device is an optical unit 40 being combined to a module being surrounded by a housing 40a. Thereby, the optical unit 40 is pivotable about the rotary axis 34 so that the optical unit 40 for visual inspection of the defects on the edge region 6a of the wafer 6 can be pivoted in a position in which said optical unit 40 basically faces the top surface 30 of the edge of the wafer 6a. The positioning of the optical unit 40 is basically carried out as shown in FIG. 4. Likewise, the optical unit 40 can be pivoted in a position in which the optical unit 40 faces the bottom side 31 of the edge of the wafer 6a. By all means, the optical unit 40 is always being pivoted in such a way that the optical axis 33c of the just used objective 33 is perpendicular to the area which should be captured on the edge of the wafer 6a. As apparent from FIG. 4, there is a plurality of positions for the image acquisition. Although basically three positions are described in the description, this should not be regarded as limiting the invention. In a third position (as shown in FIG. 5) the optical unit 40 for visual assessment of defects on the edge of the wafer 6a (and edge region of the wafer respectively) is basically situated directly opposite to the face 32 of the wafer 6. The optical unit 40 thereby comprises at least one objective 33, with which the defects can be captured with a defined image field (not shown). Furthermore, the optical unit 40 comprises a detector 44, which can be designed as a CCD-chip. The detector 44 is arranged in the detection beam path 48. The detection beam path 50 and the illumination beam path 41 are being combined with a beam splitter 50. The illumination device 41 is provided in the illumination beam path 49. Likewise, the light 51 of a focusing device 42 can be coupled in with the illumination beam path and detection beam path respectively via a beam splitter 45. A lense and an optic 43 respectively can be further provided in front of the detector 44 in the detection beam path 48.

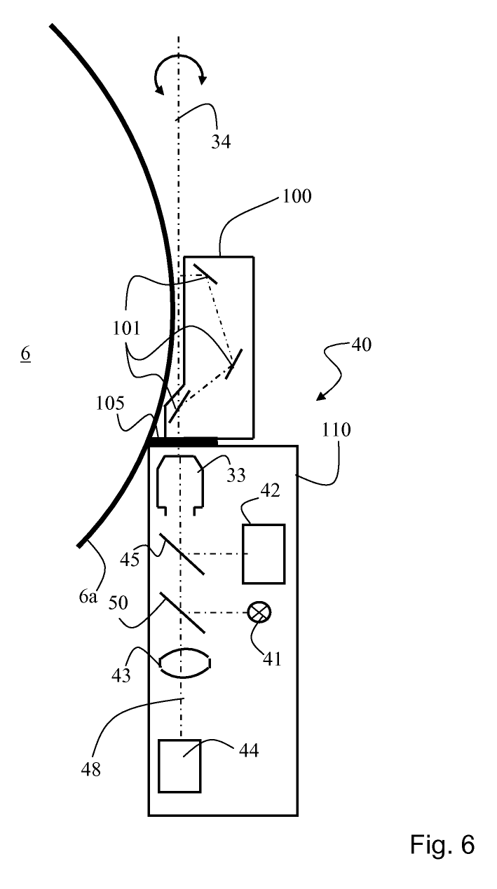

FIG. 6 shows another embodiment of the device for recording images of defects on the edge region 6a of a wafer 6. The optical unit 40 is thereby subdivided into a first pivotable module 100 and in a stationary second module 110. The pivotable first module 100 and the stationary second module 110 are connected via a joint 105 with each other. The pivotable first module 100 is pivotable about the rotary axis 34 so that the first pivotable module 100 can detect defects according to requirements on the top surface 30 of the edge of the wafer 6a, on the bottom surface 31 of the edge of the wafer 6a or on the face 32 of the edge of the wafer. The first pivotable module 100 has several mirrors 101, which route the light coming from the surface of the wafer to an objective 33 which is provided in the stationary second module 110. Thereby, the objective 33 is positioned directly behind the joint 105. In the stationary second module 110, the focusing device 42, a lense 43, an illumination device 41 and the detector 44, which is designed as a CCD-Chip, are arranged. Likewise, several mirrors and beam splitters 45, 50 respectively are arranged in the stationary second module 110 for redirecting the illumination light and the light for the focusing device 42.

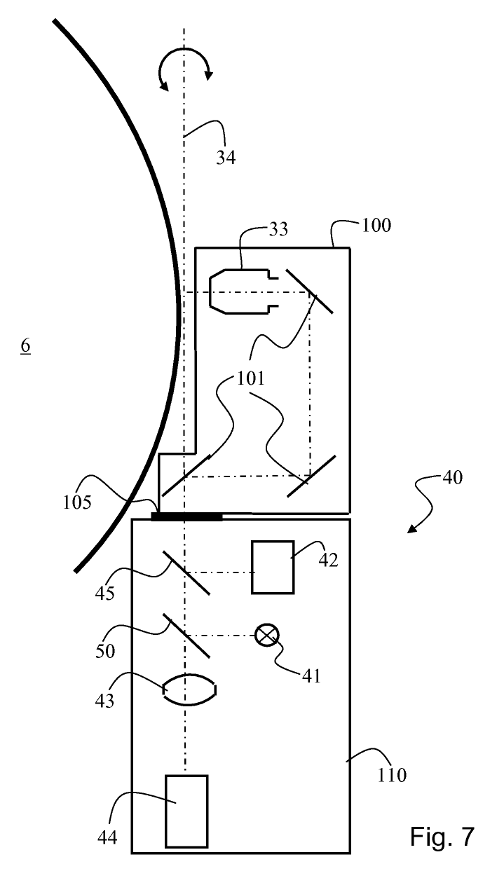

FIG. 7 shows another embodiment of the invention, wherein the optical unit 40 is subdivided in a rotatable first module 100 and a stationary second module 110. As already described in FIG. 6, the movable and pivotable module 100 respectively is connected via a joint 105 with the stationary module 110. It is advantageous, if heavy elements are provided in the stationary module. This has the advantage that no great masses need to be moved with the pivotable module 100 which facilitates the positioning and the alignment of said pivotable module 100 considerably. The stationary second module 110 can also be described as a sensor module. In the pivotable module 110, an objective 33 is arranged, which can directly be positioned opposite to the edge of the wafer 6. The light collected from the objective 33 is routed via a plurality of mirrors 101 to the joint and to the rotating axis 34 respectively. The light enters into the stationary module 110 via the joint 105 and is there correspondingly recorded on the detector 44.

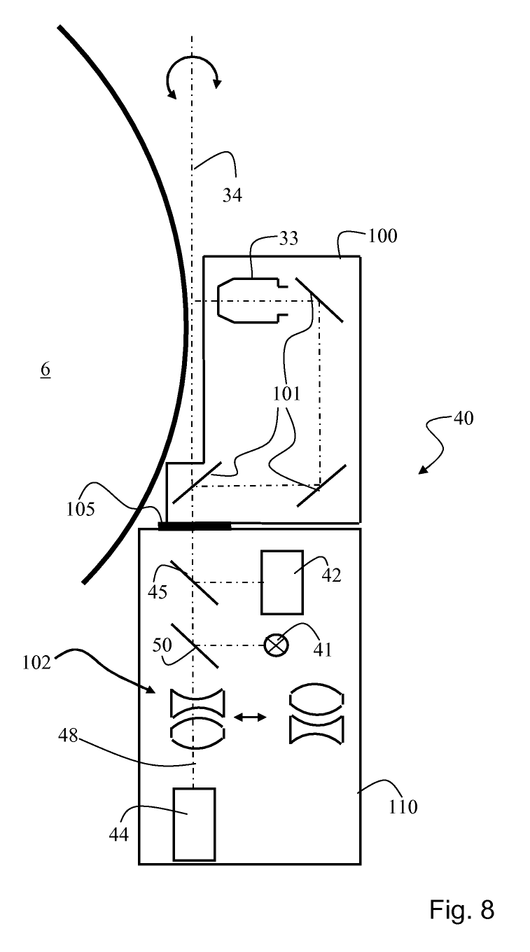

In FIG. 8, an embodiment of the device for visual assessment of defects on the edge of the wafer is shown which is similar to the embodiment shown in FIG. 7. The difference is that a magnification changer 102 is provided directly in front of the CCD-chip in the stationary first module 110 of the optical unit 40. The magnification changer 102 thereby comprises a plurality of tube lenses with a 0.5 to 2.5 times magnification, which can be inserted in front of the detector 44 in the detection beam path 48.

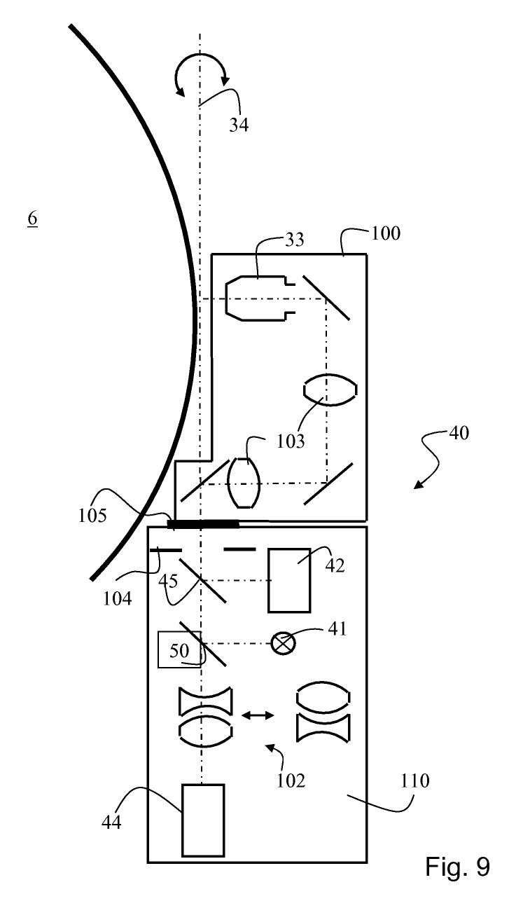

FIG. 9 shows another embodiment of the device for assessment of defects on the top surface 30, the bottom surface 31 and the face 32 of the edge of the wafer 6a, which is comparable with the embodiment in FIG. 8. The embodiment in FIG. 9 differs from the embodiment in FIG. 8 in such a way that at least an afocal system 103 is provided in the pivotable first module 100 of the optical unit 40. In addition, a variable aperture diaphragm 104 is provided directly past the joint 105 in the stationary second module 110.

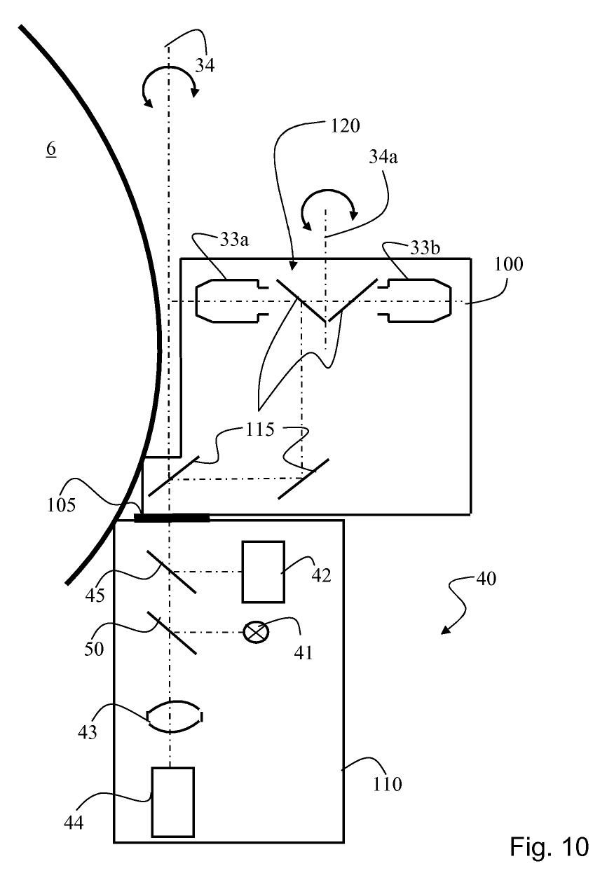

FIG. 10 describes another embodiment of the device for the inspection of defects on the edge of the wafer 6. A turret 120 is provided in the pivotable module 100, which is rotatable about a rotary axis 34a. The rotary axis 34a is aligned parallel to the rotary axis 34, about which the entire pivotable first module 100 is rotatable and pivotable respectively. Different objectives 33a, 33b with different magnification can be positioned with the rotary axis 34a opposite of the edge of the wafer 6a in order to capture images of the defects with a desired magnification. The objectives 33a, 33b provided on the turret 120 vary in their magnification. The light captured by a respective objective is being routed into the stationary second module 110 by means of a mirror system 115. The light gets into the stationary second module 110 via the joint 105.

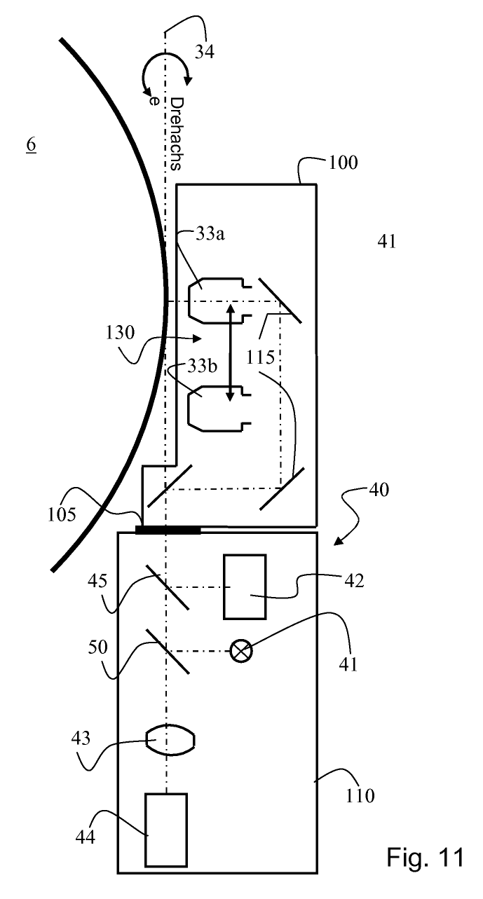

The embodiment shown in FIG. 11 shows another embodiment of the embodiment shown in FIG. 10. Hereby, the turret 120 is replaced by a slider 130. The slider 130 carries at least two objectives 33a, 33b, which are different in their magnification.

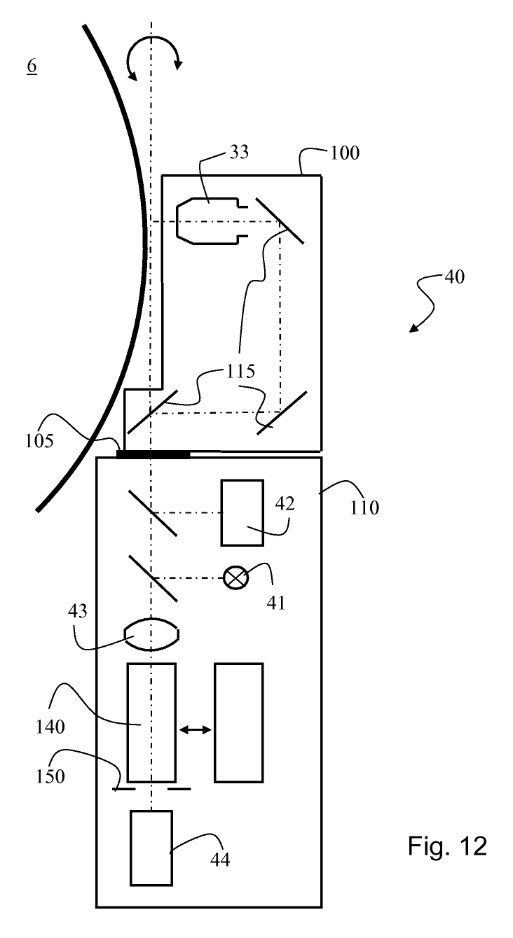

FIG. 12 shows another embodiment of the device for assessment of defects on the edge 6a of a wafer 6, wherein an objective is provided in the pivotable module 100 having a definite magnification. In the stationary module a magnification changer 140 is provided in front of the CCD-chip 44. An aperture diaphragm 150 is positioned between the magnification changer 140 and the CCD-chip.

A resolution of 0.5 μm shall be achieved with the device for the inspection of defects on the edge of a wafer. Thereby, a numeric aperture of >=0.53 shall be reached. A depth of focus of <=4.5 μm is necessary so that the device also contains a focusing system 42 and an auto focusing system respectively. The detection is carried out with a camera comprising a CCD-chip having a pixel size of approximately 5 μm so that approximately 5 pixel are necessary for the image of a structure having the size of 0.5 μm which approximately corresponds to a 50× magnification. It is possible to provide a switchable magnification in the range of 10× to 50× as shown in some embodiments. The realization of this resolution is possible by means of a definite objective with a 20× magnification and switchable tube lenses with a 0.5× to 2.5× magnification. Another realization is possible with changeable objectives having a 10× to 50× magnification and a fixed tube lense. As for an objective with a 50× magnification, the visual field diameter reduces to approximately 110 μm.

As already set forth in the description of the individual figures, the device for the inspection of defects on the edge of the wafer 6a consists in an embodiment of a pivotable module 100 and a stationary module 110. The wafer 6 is being rotated in such a way that an image of the defect can be captured by the device. The coordinates of the defect to be examined on the top surface 30, the bottom surface 1 and the face 32 of the edge of the wafer 6a can derive from a working station for the inspection of the edge of the wafer 6a, for example, which is arranged in the inspection device. Furthermore, it is possible that the coordinates for a defect to be examined are being transferred from a database to the rotating device for the wafer and that said wafer being accordingly rotated so that the defect can be captured by the device and assessed. According to the coordinates of the defect, the wafer is being rotated as long as said defect is positioned in the pivoting plane of the optical axis of the objective. Simultaneously, the objective is being pivoted about the wafer tangent on the position of the defect as long as the optical axis of the device impinges onto the defect. Finally, an accurate positioning and a focusing follow so that the defect can be captured effectively by the device. The fine positioning and focusing can be carried out by adjusting the wafer stage in X-/Y-/Z-direction. This adjustment can also be combined with an objective focusing if necessary.

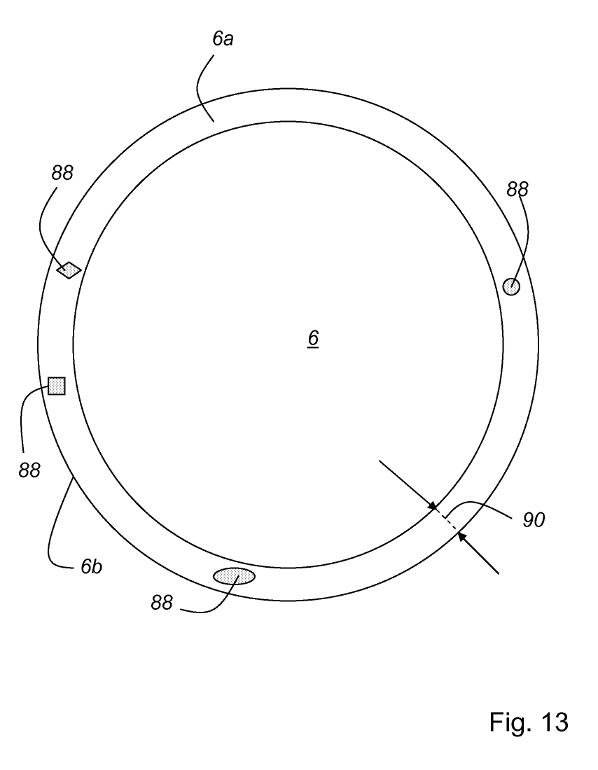

FIG. 13 shows a top view onto the top surface 30 of a wafer 6. The wafer 6 is provided with an edge region 90, onto which a plurality of defects 88 can be available. The wafer 6 is also provided with a face 32, which is being captured by pivoting the device 40 about a rotating axis as already mentioned beforehand.

While this invention has been particularly shown and described with references to preferred embodiments thereof, it will be understood by those skilled in the art that various changes in form and details may be made therein without departing from the scope of the invention encompassed by the appended claims.

What is claimed is:

1. A device for the inspection of defects on an edge region of a wafer comprising:
at least one illumination device, which illuminates the edge region of the wafer;
a detector, which captures an image of the edge region of the wafer with a defined image field size; and
at least an optical unit, wherein said optical unit being positionable subject to the position of the defect relative to a top surface of the edge of the wafer or a bottom surface of the edge of the wafer or a face of the edge of the wafer for capturing an image of said defect.

2. The device of claim 1, wherein the at least one illumination device is designed in such a way that a plurality of illuminating techniques and/or contrast methods is realizable.

3. The device of claim 2, wherein the illuminating techniques and/or contrast methods are the bright field illumination, the dark field illumination, the interference contrast and the differential interference contrast.

4. The device of claim 1, wherein each optical unit is provided with a module arranged pivotable about an axis having at least one objective for illumination and image acquisition of the defect, the at least one illumination device and the detector and a focusing device.

5. The device of claim 1, wherein the at least one optical unit having a first pivotable module having at least an objective and a mirror arrangement, which is connected via a joint with a stationary second module comprising at least one optics for illumination and image acquisition of the defect, the illumination device, the detector and a focusing device.

6. The device of claim 1, wherein the optical unit having a first pivotable module having a mirror arrangement, wherein said mirror arrangement is connected via a joint with a stationary second module having the illumination device, the detector and a focusing device.

7. The device of claim 1, wherein in the detection beam path a magnification changer is provided in front of the detector.

8. The device of claim 7, wherein in the detection beam path in front of the detector the magnification changer in front of the detector having a pupil.

9. The device of claim 5, wherein a variable aperture diaphragm is positioned in the stationary second module past the joint.

10. The device of claim 9, wherein at least one lense in addition to the objective is provided in the pivotable first module.

11. The device of claim 1, wherein the optical unit having at least two objectives and one mirror arrangement, which are positioned in a pivotable first module and wherein the pivotable first module is connected via a joint with a stationary second module having at least the illumination device, the detector and a focusing device.

12. The device of claim 11, wherein the at least two objectives are positioned on a rotatable turret.

13. The device of claim 11, wherein the at least two objectives are positioned on a slider.

14. A method for the inspection of defects on the edge region of a wafer, comprising the following steps:
positioning the wafer on the basis of stored positioning data in such a way that the defects for inspection are located in the image area of at least one optical unit;
positioning the at least one optical unit for image acquisition with a detector subject to the position of the defect relative to the top surface of the edge of the wafer or to the bottom surface of the edge of the wafer or to the face of the edge of the wafer; and
displaying the captured images for the user on a display or storing said captured images for later processing.

15. The method of claim 14, wherein at least one illumination device is provided, wherein the at least one illumination device is designed in such a way that a plurality of illumination techniques and/or contrast methods is realizable.
